(19) United States
(12) Patent Application Publication
(10) Pub. No.: US 2013/0054135 A1
(43) Pub. Date: Feb. 28, 2013

(54) ELECTRONIC CARTAGE APPLICATION

(71) Applicant: Ragnar H. Backsen, JR., Westminster, CO (US)

(72) Inventor: Ragnar H. Backsen, JR., Westminster, CO (US)

(21) Appl. No.: 13/601,903

(22) Filed: Aug. 31, 2012

Related U.S. Application Data
(60) Provisional application No. 61/529,396, filed on Aug. 31, 2011.

(51) Int. Cl. G06Q 10/08; G06F 17/00; G06Q 30/02; G01C 21/00; G06Q 40/00; G06Q 20/20

(52) U.S. Cl. 701/425; 705/341; 705/31; 705/16; 705/14.4; 701/300

(57) ABSTRACT

An apparatus for an electronic cartage application includes a log module configured to maintain a log of cartage operator status entries for a cartage operator. The apparatus includes a comparison module configured to compare the log of cartage operator status entries for a particular time period with automated movement data for a vehicle operated by the cartage operator during the particular time period. The apparatus includes a detection module configured to detect a difference between the log of cartage operator status entries and the automated movement data that exceeds a predetermined threshold.

### CROSS-REFERENCES TO RELATED APPLICATIONS

This application claims the benefit of U.S. Provisional Patent Application Ser. No. 61/529,396 entitled “An Electronic Cartage Application” and filed on Aug. 31, 2011 for Ragnar H. Backsen Jr., which is incorporated herein by reference.

### BACKGROUND

1. Field

The subject matter disclosed herein relates to an electronic cartage application and more particularly relates to a healthcare and wellness web platform.

2. Description of the Related Art

Commercial cartage services are traditionally provided by drivers, truckers or pilots of commercial vehicles (“cartage operators”). Cartage operators may be independent or may belong to trucking organizations of various sizes. The services rendered include the transport and delivery of goods, freight, and substances to specific locations indicated by a delivery manifest. These transport services, tend to be highly regulated by state, provincial, and national legislation, often producing large amounts of administrative and compliance paperwork.

In addition to the demands of the road, cartage operators typically deal with loading unloading of goods, vehicle maintenance, bills of lading, accounting, fuel and supplies, taxes, regulation compliance, and the like.

### BRIEF SUMMARY

From the foregoing discussion, it should be apparent that a need exists for an apparatus, system, and method for an electronic cartage application that manages and assists with one or more cartage operations. Beneficially, such an apparatus, system, and method would assist a cartage operator.

The present subject matter has been developed in response to the present state of the art, and in particular, in response to the problems and needs in the art that have not yet been fully solved by currently available cartage applications. Accordingly, the present invention has been developed to provide an apparatus, system, and method for an electronic cartage application that overcome many or all of the above-discussed shortcomings in the art.

In one embodiment, an apparatus for an electronic cartage application includes a log module configured to maintain a log of cartage operator status entries for a cartage operator. In one embodiment, the apparatus includes a comparison module configured to compare the log of cartage operator status entries for a particular time period with automated movement data for a vehicle operated by the cartage operator during the particular time period. In one embodiment, the apparatus includes a detection module configured to detect a difference between the log of cartage operator status entries and the automated movement data that exceeds a predetermined threshold.

In one a further embodiment, the apparatus includes a depiction module configured to visually depict a comparison of the log of cartage operator status entries and the automated movement data. In one embodiment, the apparatus includes a notification module configured to generate a notification in response to the detection module detecting the difference between the log of cartage operator status entries and the automated movement data that exceeds the predetermined threshold.

The apparatus, in some embodiments, includes a log module configured to determine an operator status of the cartage operator and automatically generate an operator status entry in the log in response to determining the operator status of the cartage operator. In one embodiment, the apparatus includes a fuel reference module configured to reference fueling data of one or more fuel purchase transactions for the vehicle. The fueling data may be from the one or more fuel purchase transactions. The apparatus, in one embodiment, includes a movement reference module configured to reference movement data for the vehicle. The movement data may include a distance traveled by the vehicle in one or more jurisdictions. In one embodiment, the apparatus includes a calculation module configured to calculate an International Fuel Tax Agreement (“IFTA”) tax for the one or more jurisdictions from the fueling data and the movement data.

In a further embodiment, the fueling data is collected at a point of sale (“POS”) terminal and collected as part of a point of sale fuel discount program. In one embodiment, the apparatus includes an interface module configured to interface with a fleet fuel card entity and retrieve the fueling data from the fleet fuel card entity. In certain embodiments, the apparatus includes a station determination module configured to determine a plurality of fueling stations within a predetermined distance of a route of the vehicle. In a further embodiment, the apparatus includes a fuel price reference module configured to reference current discounted fuel prices for the plurality of fueling stations. The discounted fuel prices may be based on a discount program. In one embodiment, the apparatus includes a indicator display module configured to display fuel price indicators for the plurality of fueling stations on a navigation display. The fuel price indicators may include the discounted fuel prices. In a further embodiment, the apparatus includes a direction module configured to provide navigation directions to a particular fueling station in response to receiving a user selection of the particular fueling station.

In one embodiment, the apparatus includes a location determination module configured to determine a current location of the vehicle. In one embodiment, the apparatus includes a boundary determination module configured to determine whether the current location of the vehicle is within a boundary. The boundary may be around a point of interest. In one embodiment, the apparatus includes a presentation module configured to display a presentation over a portion of a pre-existing image of a display in response to the boundary determination module determining that the current location of the vehicle is within the boundary, the presentation associated with the point of interest. The pre-existing image may remain substantially visible with the presentation on the display.

In a further embodiment, the point of interest includes a commercial entity and the presentation includes an advertisement for the commercial entity. In one embodiment, the apparatus includes a POI determination module configured to determine one or more points of interest. Each point of interest may be one or more of within a predetermined area from a location of the vehicle and along a predetermined route of the vehicle.

In one embodiment, the presentation includes a video and the apparatus includes a presentation receiving module configured to receive one or more presentations at a console in communication with the display and configured to store the one or more presentations. The one or more presentations may be for points of interest one or more of a predetermined distance from a location of the vehicle and along a predetermined route of the vehicle. The presentation module may be configured to display the presentation over the portion of the pre-existing image of the display by displaying a stored presentation from the console.

In one embodiment, the apparatus includes a protected status module configured to place a console including cartage data in a protected status. The cartage data may be produced by a plurality of cartage applications executing on the console. In one embodiment, the apparatus includes a limited display module configured to display a limited subset of cartage data on a display in communication with the console. In one embodiment, the apparatus includes a monitoring module configured to monitor for an access attempt to retrieve information stored on the console.

In a further embodiment, the apparatus includes an erase module configured to erase a memory of the console in response to detecting an erase event. The erase event may include one of an access attempt and receiving an erase command from a remote application.

A method for an electronic cartage application includes maintaining a log of cartage operator status entries for a cartage operator. In one embodiment, the method includes comparing the log of cartage operator status entries for a particular time period with automated movement data for a vehicle operated by the cartage operator during the particular time period. In one embodiment, the method includes detecting a difference between the log of cartage operator status entries and the automated movement data that exceeds a predetermined threshold.

In one embodiment, the method includes determining a current location of the vehicle. In one embodiment, the method includes determining whether the current location of the vehicle is within a boundary. The boundary may be around a point of interest. In one embodiment, the method includes displaying a presentation over a portion of a pre-existing image of a display in response to determining that the current location of the vehicle is within the boundary. The presentation may be associated with the point of interest and the pre-existing image may remain substantially visible with the presentation on the display.

The method, in one embodiment, includes referencing fueling data of one or more fuel purchase transactions for the vehicle. The fueling data may be from the one or more fuel purchase transactions. In one embodiment, the method includes referencing movement data for the vehicle. The movement data may include a distance traveled by the vehicle in one or more jurisdictions. The method includes, in one embodiment, calculating an International Fuel Tax Agreement (“IFTA”) tax for the one or more jurisdictions from the fueling data and the movement data.

A computer program product comprising a computer readable storage medium storing computer usable program code executable to perform operations for an electronic cartage application. In one embodiment, the operations include maintaining a log of cartage operator status entries for a cartage operator. In one embodiment, the operations include comparing the log of cartage operator status entries for a particular time period with automated movement data for a vehicle operated by the cartage operator during the particular time period. In one embodiment, the operations include detecting a difference between the log of cartage operator status entries and the automated movement data that exceeds a predetermined threshold.

In one embodiment, the operations include placing a console comprising cartage data in a protected status. The cartage data may be produced by a plurality of cartage applications executing on the console. In a further embodiment, the operations include displaying a limited subset of cartage data on a display in communication with the console and monitoring for an access attempt to retrieve information stored on the console.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

In order that the advantages of the present subject matter will be readily understood, a description of the subject matter will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 is a schematic block diagram illustrating one embodiment of a system for an electronic cartage application in accordance with the present subject matter;

FIG. 2 is a schematic block diagram illustrating another embodiment of a system for an electronic cartage application in accordance with the present subject matter;

FIG. 3 is a schematic block diagram illustrating one embodiment of an apparatus for an electronic cartage application in accordance with the present subject matter;

FIG. 4 is a schematic block diagram illustrating another embodiment of an apparatus for an electronic cartage application in accordance with the present subject matter;

FIG. 5 is a schematic block diagram illustrating one embodiment of yet another apparatus for an electronic cartage application in accordance with the present subject matter;

FIG. 6 is a schematic block diagram illustrating one embodiment of yet another apparatus for an electronic cartage application in accordance with the present subject matter;

FIG. 7 is a schematic block diagram illustrating one embodiment of yet another apparatus for an electronic cartage application in accordance with the present subject matter;

FIG. 8A illustrates one embodiment of a display of cartage operator status entries in accordance with the present subject matter;

FIG. 8B illustrates one embodiment of a user interface for editing a cartage operator log;

FIG. 8C illustrates another embodiment of a user interface for editing a cartage operator log;

FIG. 8D illustrates one embodiment of a user interface for approving cartage operator status entries;

FIG. 9A a schematic map illustrating one embodiment of points of interest with boundaries in accordance with the present subject matter;

FIG. 9B illustrates one embodiment of a presentation displayed over a portion of a pre-existing image in accordance with the present subject matter;

FIG. 10 is a schematic flow chart illustrating one embodiment of a method for a log of cartage operator status entries in accordance with the present subject matter;

FIG. 11 is a schematic flow chart illustrating one embodiment of a method for calculating an IFTA tax in accordance with the present subject matter;

FIG. 12 is a schematic flow chart illustrating one embodiment of a method for displaying fuel price indicators for a plurality of fueling stations in accordance with the present subject matter;

FIG. 13 is a schematic flow chart illustrating one embodiment of a method for displaying a presentation in accordance with the present subject matter; and

FIG. 14 is a schematic flow chart illustrating one embodiment of a method for placing a console in a protected status in accordance with the present subject matter.

### DETAILED DESCRIPTION

As will be appreciated by one skilled in the art, aspects of the present subject matter may be embodied as an apparatus, system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (“RAM”), a read-only memory (ROM), an erasable programmable read-only memory (“EPROM” or Flash memory), an optical fiber, a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

Aspects of the present subject matter are described below with reference to schematic flowchart diagrams and/or schematic block diagrams of methods, apparatuses, systems, and computer program products according to embodiments of the subject matter. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present subject matter. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

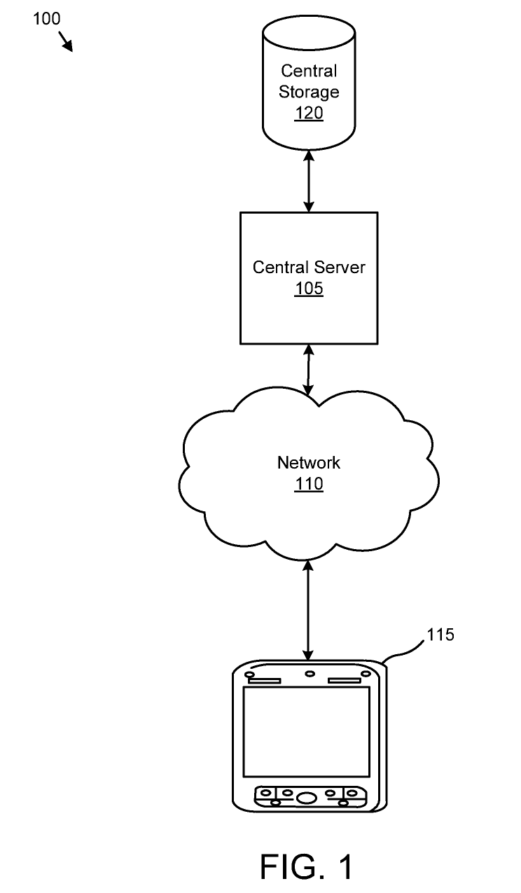

FIG. 1 illustrates one embodiment of a system 100 for an electronic cartage application. The system 100 includes a central server 105, a network 110, and a client 115. The central server 105 may one or more of host, store, support, include, interface with and provide one or more electronic cartage applications. The central server 105 may interface with the client 115 over the network 110. The central server 105 may communicate with a central database stored in central storage 120 to store cartage application data, cartage operator log data, navigation data, and the like.

The central server 105 may be embodied as a computing device such as a desktop computer, a server, a mainframe computer, and the like. The central server 105 may include memory storing computer readable programs and may include one or more processors that execute the computer readable programs as is well known to those skilled in the art. The computer readable programs may be tangibly stored in storage in communication with the central server 105. Although a single central server 105 is depicted, in certain embodiments, the system may include multiple servers and may be implemented using cloud computing with multiple server-based computational resources.

The network 110 may comprise a global communications network 110 such as the Internet, a Local Area Network (“LAN”), multiple LANs communicating over the internet, or any other similar communications network 110. In one embodiment, the network 110 comprises a mobile phone telecommunications network such as a 3G or 4G network.

The client 115 may be embodied as a desktop computer, a portable computer, a handheld computing device, a touch device, a personal desktop assistant (“PDA”), a tablet computer, a mobile phone, a Smartphone, or the like. In one embodiment, the client 115 is a console that one or more of includes and is in communication with an electronic display, such as a liquid crystal display (“LCD”), plasma display, or other suitable display. In one embodiment, the display is a touch display capable of receiving touch input as is known in the art. The client 115 may be in communication with a navigational device such as a Global Positioning System (“GPS”) device. The navigational device allows vehicles or load components to be tracked by satellite and communicate location and destination information to the console and to distributed and centralized operations of the system. The navigational device may include a navigation map interface to display a navigation map and navigation directions on the client 115.

In one embodiment, the navigational device issues alerts or warnings (textual prompts, auditory prompts, or the like through the client 115 to warn of highway conditions along a route. The navigational device may communicate such information as an alert of a live railroad crossing, an accident, heavy traffic, and the like. In one embodiment, the navigational device senses the vehicle cross a geofence (e.g. a boundary around a location, such as a railroad crossing, accident scene, or the like) and may alert the driver in response to crossing the geofence.

In one embodiment, the client 115 may receive a signal from certain vehicles, such as emergency vehicles, including the certain vehicle's location and, using the navigational device, may determine whether the vehicle (e.g. in which the client 115 resides) is within a predetermined distance of the certain vehicle and may also determine if the vehicle is along a route of the certain vehicle. For example, in one embodiment, emergency vehicles may transmit messages alerting the client 115 that the emergency vehicle is responding to an emergency. In one embodiment, the messages are transmitted with SMS. The client 115 may alert the cartage operator that an emergency vehicle is approaching and, in some embodiments, display a location of the emergency vehicle on a display of the client 115.

In one embodiment, the client 115 is one of integrated with and located in a vehicle for operation by a cartage operator (e.g. a driver). In one embodiment, the client 115 is used by a customer load dispatcher to dispatch various customer loads to cartage operators.

One or more electronic cartage applications may operate on the client 115. In one embodiment, at least a portion of the one or more electronic cartage applications comprise computer readable programs stored on memory of the client 115. In one embodiment, the client 115 interacts with the central server 105 periodically when executing the one or more cartage applications. For example, the client 115 may be periodically backed up by synchronization with the central server 105/central storage 120. This may be done automatically, such as every 30 to 60 minutes, so as to keep a back-up copy sufficiently current while minimizing any interruption to the user. In one embodiment, the client 115 communicates with the central server 105 using SMS messages. During or separate from this synchronization process, the client 115 may also be updated with any updates or software changes. The client 115 may also include a user interface for access to the one or more cartage applications. The user interface may include a graphical user interface for presentation and interaction on the display of the client 115.

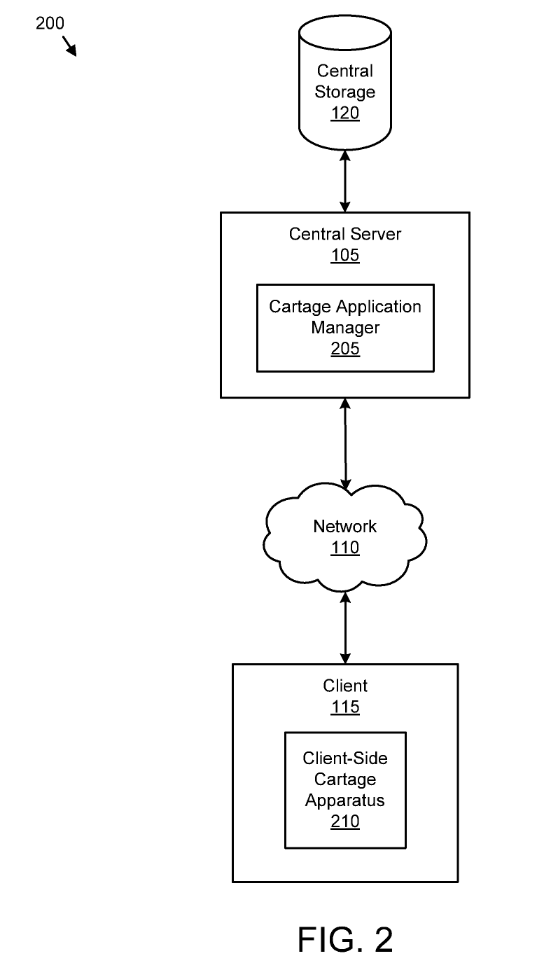

FIG. 2 illustrates another embodiment of a system 200 for an electronic cartage application. The description of the system 200 refers to elements of FIG. 1, like numbers referring to like elements. The system 200 includes the central storage 120, the central server 105, the network 110, and the client 115, that may be substantially similar to the like numbered elements depicted in FIG. 1.

The central server 105 includes a cartage application manager 205. While the server 205, in the depicted embodiment, includes the cartage application manager 205, in certain embodiments, all or a portion of the cartage application manager 205 may reside and/or be embodied outside the central server 105. The cartage application manager may reside on a single server or multiple servers. The cartage application manager 205 may communicate with one or more clients 115 to save cartage application data, generate reports using the cartage application data, perform analysis on the cartage application data, and the like. Cartage application data may include data associated with one or more cartage applications operating on a client 115. Cartage application data may include data that is part of a client-side cartage apparatus 210 as described below and may include cartage operator log information, navigation information, fuel information, mileage information, and the like.

In one embodiment, the cartage application manager 205 provides customer loads to which individual cartage operators may view and accept. The cartage application manager 205 may assign a customer load to a cartage operator in response to the cartage operator accepting the customer load by way of an interface on the client 115.

In one embodiment, dispatching information may be sent to the client 115 via SMS (or other suitable communication protocol), allowing the user to select one of several available loads, with that choice automatically being communicated back to the cartage application manager 205 via the same SMS facility. In one embodiment, the cartage application manager 205 may send available loads to a particular cartage operator (via the client 115) based on work shift data from the cartage operator log (e.g. to determine the particular cartage operator's available hours). For example, if the number of hours needed to complete a particular load by a certain date exceeds the number of hours a particular cartage operator has available (e.g. before he has to take a 34 hour break), the cartage application manager 205 may not send the particular load to the particular cartage operator (e.g. the client 115 for the particular cartage operator).

In one embodiment, the cartage application manager 205 may send available loads to a particular cartage operator based various profiles such as, but not limited to one or more of a driver profile, a tractor profile, and a trailer profile. Each profile may include various parameters. A driver profile may include parameters and/or preferences set by the particular cartage operator. For example, a cartage operator may set parameters to specify what customer loads the cartage operator would be interested in receiving at the client 115. These parameters may include, but are not limited to pick-up location, drop-off location, payment per mile, type of goods, customer identity, and the like. The tractor and the trailer profiles may include parameters based on characteristics of the tractor or trailer such as weight restrictions/capabilities, type of trailer (e.g. dry van or flatbed), and the like. In one embodiment, the cartage application manager 205 sends available loads to a particular cartage operator (e.g. the client 115 for the cartage operator) that meets the parameters and/or preferences of the driver profile, tractor profile, and/or trailer profile associated with the client 115 of that cartage operator, tractor, and/or trailer.

The client 115 includes the client-side cartage apparatus 210. The client-side cartage apparatus 210 may collect cartage application data, may analyze cartage application data, display information to a cartage operator, such as a vehicle driver, and the like. The client-side cartage apparatus 210 may communicate with the cartage application manager to receive software updates, back up cartage application data, and the like. The client-side cartage apparatus 210 may be in communication with a navigation device, such as a GPS device and may include an enhanced logging system to log cartage operator status entries in accordance with Department of Transportation requirements. The client-side cartage apparatus 210 may receive dispatch destination information from the cartage application manager 205 and coordinate with the navigation device to provide driving directions for load pickup or delivery. In one embodiment, the client-side cartage apparatus 210 may track personal time. In one embodiment, the client-side cartage apparatus maintains a “personal” status in a log. In one embodiment, the client-side cartage apparatus 210 tracks detention time, or time spent at a dock waiting to pick up or drop off a load.

In one embodiment, the client-side cartage apparatus 210 receives dispatching information from the cartage application manager 205, allowing the cartage operator to select one of several available loads. In one embodiment, the client-side cartage apparatus 210 may display available loads to a particular cartage operator based on the profiles described above with one or more of parameters set by the particular cartage operator and characteristics of the tractor and/or trailer. These parameters may specify what customer loads the cartage operator would be interested in viewing on the client 115. These parameters may include, but are not limited to time, pick-up location, drop-off location, payment per mile, type of goods, customer identity, weight of goods, and the like. The display on the client 115 may show various available customer loads with information such as a location, a picked time, a contact number, and the like. The client-side cartage apparatus 210 may include a user interface to allow a cartage operator to select a customer load for assignment, such as through, for example, a soft button on a graphical user interface presented on a display. The client-side cartage apparatus 210 may include a dispatch screen for display by the client 115 that displays trip information, broker information, miles, driver information, pickups, drop-offs, and the like. If the client 115 is in use by a dispatcher, the client-side cartage apparatus 210 may allow a dispatcher to also view customer loads and to direct and dispatch customer loads to cartage operators.

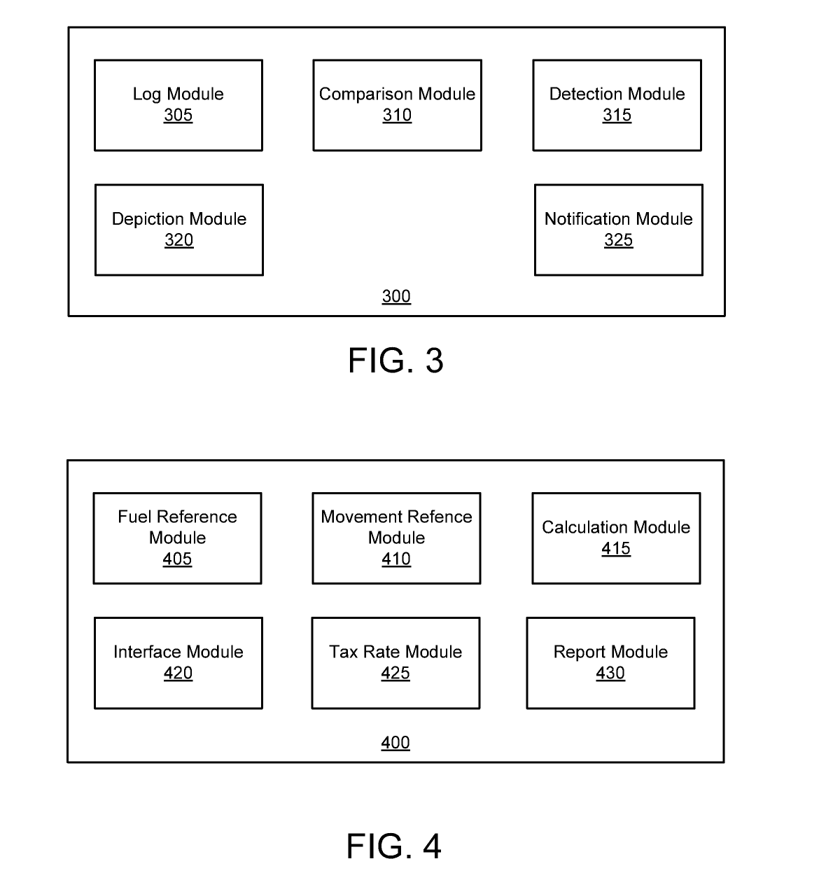

The apparatuses 300, 400, 500, 600, 700 depicted in FIGS. 3-7, as described below, may each comprise one or more of the cartage application manager 205 and the client-side cartage apparatus 210. One or more of the cartage application manager 205 and the client-side cartage apparatus 210 may include one or more of the apparatuses 300, 400, 500, 600, 700 depicted in FIGS. 3-7.

FIG. 3 illustrates one embodiment of an apparatus 300 for an electronic cartage application. Specifically, the apparatus 300 may comprise one embodiment of one or more of the cartage application manager 205 and the client-side cartage apparatus 210. Specifically, the modules in the apparatus 300 may reside in the cartage application manager 205, the client-side cartage apparatus 210, or both. The description of the apparatus 300 refers to elements of FIGS. 1-2, like numbers referring to like elements. The apparatus 300 includes one or more of a log module 305, a comparison module 310, a detection module 315, a depiction module 320, and a notification module 325.

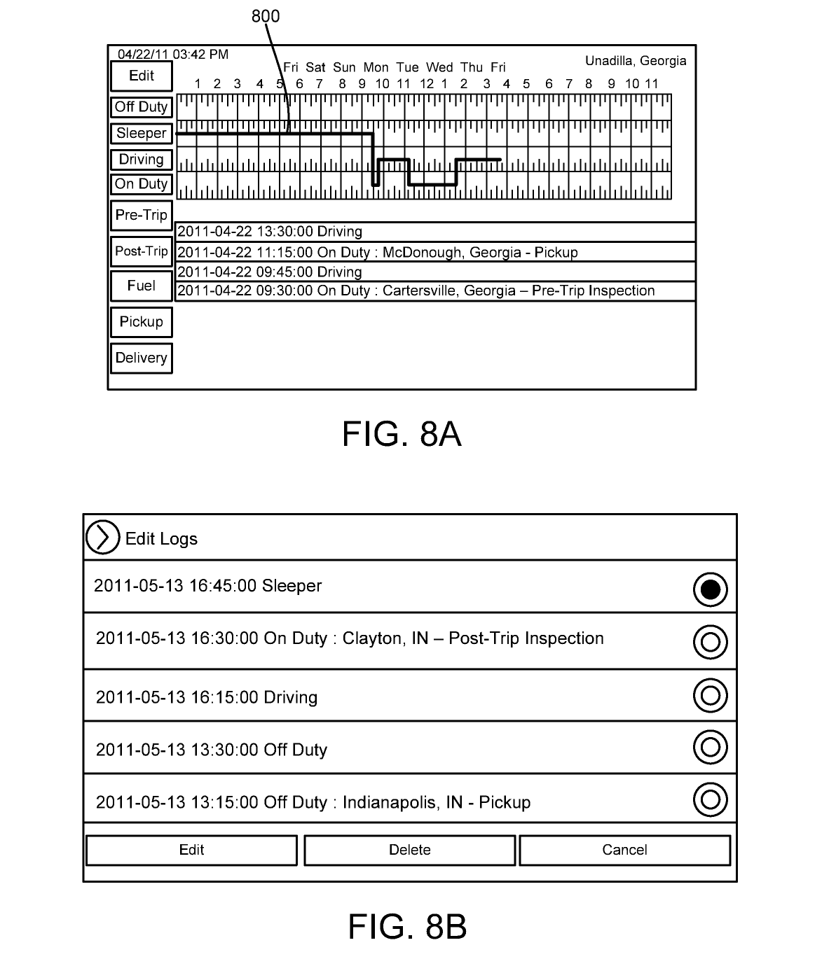

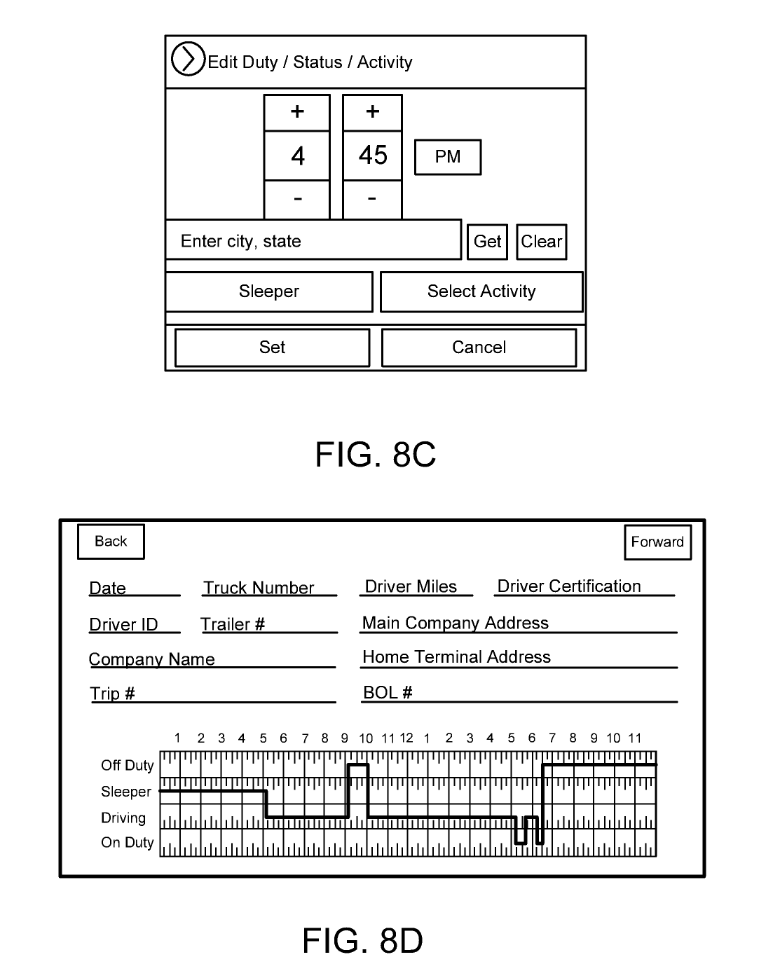

The log module 305, in one embodiment, maintains a log of cartage operator status entries (hereinafter the “log”) for a cartage operator. The cartage operator status entries, in one embodiment, are driver log entries compliant with Department of Transportation requirements and include change of duty status (on/off duty, driving, sleeper berth), and vehicle inspections. The log module 305 may one or more of communicate with and include a user interface to display cartage operator status entries over time on a display of the console. FIG. 8A depicts embodiments of the display of the cartage operator status entries. In the depicted embodiment, the log module 305 visually depicts a cartage operator status over time. The depicted embodiment, includes a graphed line 800 representing cartage operator status over time.

Referring back to FIG. 3, in one embodiment, the log module 305 communicates log information to the central server 105 periodically (e.g. every 15 minutes or other suitable time period). In one embodiment, the log module 305 forces a synchronization event with the central server 105 in response to a log entry.

In one embodiment, the log module 305 allows the cartage operator to edit that day's log. Specifically, in one embodiment, the log module 305 allows the cartage operator to change one or more first cartage operator status entries in the log for an uncommitted time period and the cartage operator is unable to change one or more second operator status entries in a committed time period. For example, a cartage operator may edit the log entries during the current day. In one embodiment, the log module 305 commits operator status entries for a particular time period and the cartage operator is unable to change the committed operator status entries. In one embodiment, the particular time period is 24 hours. For example, as soon as the cartage operator “commits” that day's log entries, the cartage operator may no longer edit those entries. In a further embodiment, the log module 305 prevents the cartage operator from entering cartage operator status entries for a next time period while a current time period is an uncommitted time period. In other words, a cartage operator, in these embodiments, may not enter log entries for the next day until the previous day's entries have been committed.

In one embodiment, the log module 305 prevents the cartage operator from making or editing a log entry that does not correlate with automated movement data. As used herein, automated movement data may include navigation data related to a particular vehicle (for which the log corresponds). Such data may include GPS data including time data, location data, speed data, and the like. The log module 305, in one embodiment, may detect differences between a would-be log entry and the movement data that exceed a predetermined threshold (e.g. 15 to 20 minutes). For example, if threshold is 20 minutes and the cartage operator attempts to edit or create a log entry showing that the cartage operator went “off-duty” at 4:00 and the movement data shows that the vehicle continued moving until 4:25, the log module 305 may detect a difference and prevent the cartage operator from making or editing the log entry. In one embodiment, the log module 305 allows the cartage operator to make or edit a log entry that conflicts with the movement data as described, but allows the cartage operator to make a note associated with the log entry to explain the discrepancy.

The log module 305 may, through the user interface, allow a cartage operator to edit log entries. Editing log entries may include selecting log entries, changing log entries, deleting log entries, and the like. FIGS. 8B and 8C show embodiments of a user interface for this purpose. The user interface may allow a user to approve cartage operator status entries. The user interface may also include a touch sensitive user interface for accepting a signature (e.g. of a cartage operator) to approve cartage operator status entries. Furthermore, FIG. 8D depicts one embodiment of a committed time period in the cartage operator log.

Referring back to FIG. 3, in one embodiment, the log module 305 determines an operator status of the cartage operator and automatically generates an operator status entry in the log in response to determining the operator status of the cartage operator. In one embodiment, the log module 305 may receive data from a navigation device, such as a GPS device. If the log module 305 detects that the vehicle has not moved for a certain period of time, the log module 305 may determine an operator status of “off duty” and may generate an operator status entry in the log of “off duty.” Likewise, if an operator status is set at “off duty” and the log module 305 detects that the vehicle has been in motion for one or more of a predetermined amount of time or a predetermined distance (e.g. a half a mile), the log module 305 may generate an operator status of “on duty” and record such in the log.

In one embodiment, when the cartage operator notifies the log module 305 (e.g. by selecting an option through a user interface of the console) of a post-trip inspection, the log module 305 may automatically log a 15-minute post-trip inspection and automatically draw a line in the log for “sleeper berth.”

The comparison module 310, in one embodiment, compares the log for a particular time period with automated movement data for a vehicle operated by the cartage operator during the particular time period. As stated above, automated movement data may include navigation data related to a particular vehicle corresponding to the log. Such data may include GPS data including time data, location data, speed data, and the like.

The detection module 315, in one embodiment, checks for differences between the log and the automated movement data. Specifically, the detection module 315 may detect any differences that exceed a predetermined threshold (e.g. 15 to 20 minutes). For example, if threshold is 20 minutes and the log shows that the cartage operator went “off-duty” at 4:00 and the movement data shows that the vehicle continued moving until 4:25, the detection module 315 may detect a difference.

In one embodiment, one or more of the comparison module 310 and the detection module 315 may be activated/deactivated. For example, an employer may activate the comparison module 310 and detection module 315 to ensure that a particular driver is complying with logging requirements. In one embodiment, one or more of the comparison module 310 and the detection module 315 are activated when the apparatus 300 is configured to meet requirements of an Electronic On-Board Recording EOBR.

The depiction module 320, in one embodiment, visually depicts a comparison of the log and the automated movement data. For example, the depiction module 320 may depict the log and the automated movement data in a common graph so that an analyst may view any differences. In a further embodiment, a line represents the log and another line represents the automated movement data. In one embodiment, the depiction module 320 visually depicts the comparison in response to the detection module 315 detecting a difference above the predetermined threshold.

The notification module 325, in one embodiment, generates a notification in response to the detection module 315 detecting the difference between the log of cartage operator status entries and the automated movement data that exceeds the predetermined threshold. The notification module 325 may generate an email, SMS message, or other suitable electronic notification.

FIG. 4 illustrates one embodiment of an apparatus 400 for an electronic cartage application. Specifically, the apparatus 400 may comprise one embodiment of one or more of the cartage application manager 205 and the client-side cartage apparatus 210. Specifically, the modules in the apparatus 400 may reside in one or more of the cartage application manager 205 and the client-side cartage apparatus 210. The description of the apparatus 400 refers to elements of FIGS. 1-2, like numbers referring to like elements. The apparatus 400 includes one or more of a fuel reference module 405, a movement reference module 410, a calculation module 415, an interface module 420, a tax rate module 425, and a report module 430.

The fuel reference module 405 references fueling data of one or more fuel purchase transactions for the vehicle. The fueling data includes, but is not limited to, fuel quantity, fuel price, fueling location, and a total fuel cost. The fueling data may be from the one or more fuel purchase transactions. In one embodiment, the fueling data is collected at a point of sale (“POS”) terminal (e.g. a gas station pump). In one embodiment, the fueling data is collected as part of a point of sale fuel discount program such as through one or more of a co-op, a fleet fuel card entity, and the like. In one embodiment, the fuel reference module 405 obtains the fueling data from one or more of the co-op or the fleet fuel card entity.

For example, the cartage operator may arrive at a fueling station and swipe the cartage operator's fleet fuel card at the station pump. The cartage operator may enter identifying information such as a password, truck number, mileage, trip number, and/or the like. One or more of the co-op and fleet fuel card entity may associate the mileage, truck number, and the like with the amount of fuel purchased and amount of the purchase, and the fuel reference module 405 may reference this data, such as through an Application Programming Interface (“API”) as described below.

In one embodiment, the client-side cartage apparatus 210 may use the fueling data acquired at the fueling station in various applications such as with the log. For example, the log module 305 may use the exact city name (e.g. the location in which fueling occurred) provided by the fueling data for the log.

The movement reference module 410, in one embodiment, references movement data for the vehicle such as GPS data. The movement data may include a distance traveled by the vehicle in one or more jurisdictions. The calculation module 415, in one embodiment, calculates an International Fuel Tax Agreement (“IFTA”) tax for the one or more jurisdictions from the fueling data and the movement data to determine how many miles the vehicle traveled in various jurisdictions along with how much fuel was purchased, the price of the fuel, and which jurisdiction the fuel was purchased in. In one embodiment, the calculation module 415 calculates the IFTA tax for the one or more jurisdictions from the fueling data and the movement data using current tax rates. In one embodiment, the calculation module 415 generates official forms for IFTA tax reporting and populates the forms with information derived from the fueling data, the movement data, and current tax rates.

In certain embodiments, the calculation module 415 calculates other forms of tax. Specifically, the calculation module, in one embodiment, calculates a weight and distance tax for states, jurisdictions, and the like, that have such a tax. The weight and distance tax may also be based on at least a portion of the information used to calculate the IFTA tax. The calculation module 415 may determine if any jurisdictions that the particular vehicle traveled through has a weight and distance tax (as not all jurisdictions have such a tax) and calculates the applicable tax for those states. The calculation module 415 may also generate and populate jurisdiction-specific forms for the weight and distance tax.

The interface module 420, in one embodiment, interfaces with a fleet fuel card entity and retrieves the fueling data from the fleet fuel card entity. In one embodiment, the interface module 420 accesses the fueling data by way of an API provided by one or more of the co-op and fleet fuel card entity or otherwise compatible with systems of one or more of the co-op and fleet fuel card entity. The tax rate module 425 obtains current tax rates such that the calculation module 415 may calculate the IFTA tax for the one or more jurisdictions from the fueling data and the movement data using the current tax rates. The report module 430 may generate a report for a particular time period from fueling data and movement data for the vehicle from the particular time period. The report module 430 may generate a full quarterly IFTA report or a preliminary report.

FIG. 5 illustrates one embodiment of an apparatus 500 for an electronic cartage application. Specifically, the apparatus 500 may comprise one embodiment of one or more of the cartage application manager 205 and the client-side cartage apparatus 210. Specifically, the modules in the apparatus 500 may reside in one or more of the cartage application manager 205 and the client-side cartage apparatus 210. The description of the apparatus 500 refers to elements of FIGS. 1-2, like numbers referring to like elements. The apparatus 500 includes one or more of a station determination module 505, a fuel price reference module 510, an indicator display module 515, and a direction module 520.

The station determination module 505, in one embodiment, determines a plurality of fueling stations within one or more of a predetermined distance of a route of the vehicle and within a predetermined distance of the vehicle. In one embodiment, the station determination module 505 one or more of includes and interfaces with a GPS navigation application and/or device to locate the plurality of fueling stations. In one embodiment, the fueling stations are those that participate in a discount program in which the cartage operator is a member.

The fuel price reference module 510, in one embodiment, references current discounted fuel prices for the plurality of fueling stations. The discounted fuel prices may be based on a discount program such as a fleet fuel card entity discount program.

The indicator display module 515, in one embodiment, displays fuel price indicators for the plurality of fueling stations on a navigation display. The fuel price indicators may include the discounted fuel prices. The indicator display module 515 may interact with a GPS navigation application and/or device to display the fuel price indicators. In one embodiment, the indicator display module 515 displays the fuel price indicators on a GPS navigation map interface showing the cartage operator fuel price indicators along a route.

The direction module 520, in one embodiment, provides navigation directions to a particular fueling station in response to receiving a user selection of the particular fueling station. The direction module 520 may include and/or interact with a GPS navigation application and/or device to provide directions to the particular fueling station. In one embodiment, the display of the console is a touch screen display sensitive to touch input. In this embodiment, the direction module 520 may receive a notification that the cartage operator has touched a particular fueling station and the direction module 520 may provide navigation directions to the particular fueling station.

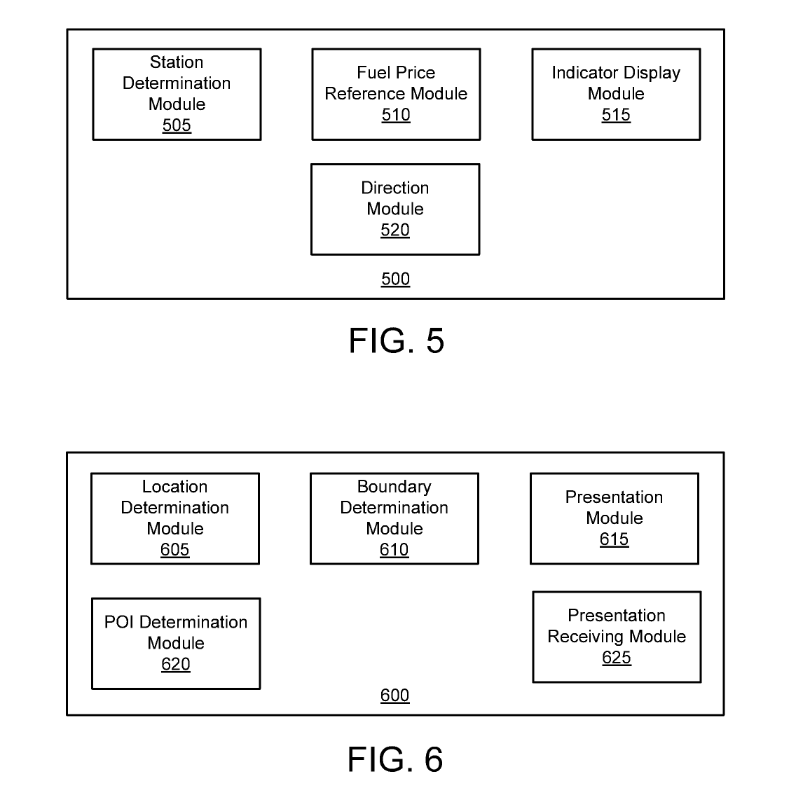

FIG. 6 illustrates one embodiment of an apparatus 600 for an electronic cartage application. Specifically, the apparatus 600 may comprise one embodiment of one or more of the cartage application manager 205 and the client-side cartage apparatus 210. Specifically, the modules in the apparatus 600 may reside in one or more of the cartage application manager 205 and the client-side cartage apparatus 210. The description of the apparatus 600 refers to elements of FIGS. 1-2, like numbers referring to like elements. The apparatus 600 includes one or more of a location determination module 605, a boundary determination module 610, a presentation module 615, a POI determination module 620, and a presentation receiving module 625.

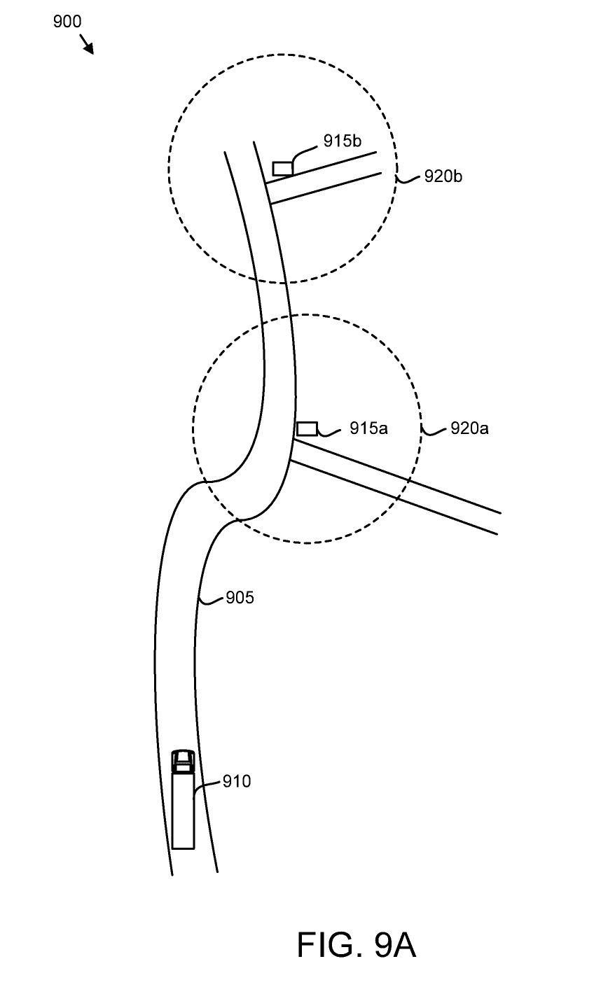

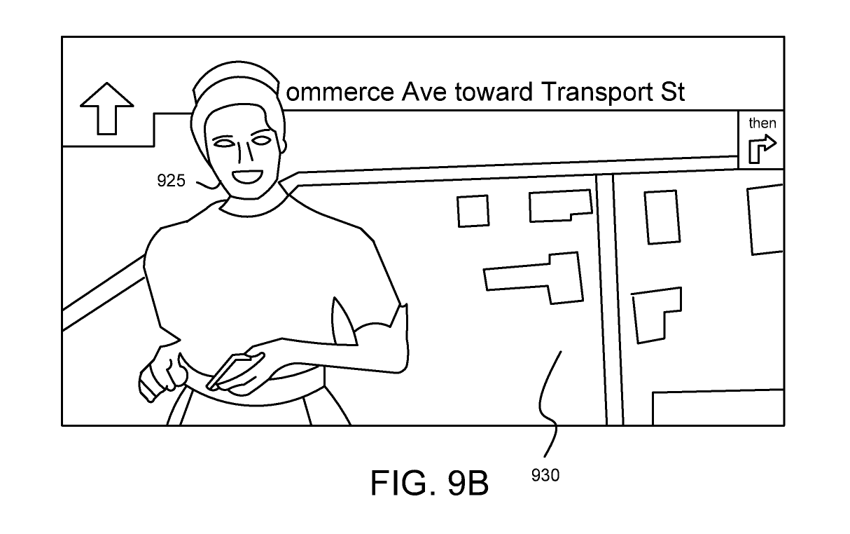

Referring also to FIG. 9A, which depicts one embodiment of a schematic map 900 with points of interest and boundaries, the location determination module 605 determines a current location of the vehicle 910. The location determination module 605 may include and/or interact with a GPS navigation application and/or device to determine a current location of the vehicle 910.

The boundary determination module 610, in one embodiment, determines whether the current location of the vehicle 910 is within a boundary 920a around a point of interest 915a. In one embodiment, the boundary determination module 610 includes and/or interfaces with a GPS navigation application and/or device to determine whether the current location of the vehicle 910 is within the boundary 920a. In one embodiment, the boundary 920a is a geo-fence and may be a radius around the point of interest 915a. In a further embodiment, the boundary determination module 610 determines whether the vehicle 910 passes the geo-fence 920a. In one embodiment, the point of interest 915a includes a commercial entity. In a further embodiment, the presentation comprises an advertisement for the commercial entity.

The presentation module 615 displays a presentation over a portion of a pre-existing image of a display in response to the boundary determination module 610 determining that the current location of the vehicle 910 is within the boundary 920a. The presentation may be associated with the point of interest 915a. The pre-existing image may include navigation information, such as a GPS navigation map showing streets, landmarks, and the like. The pre-existing image may remain substantially visible with the presentation on the display. In one embodiment, the presentation obscures not more than 30% of the pre-existing image. For example, the presentation may be displayed “over” the pre-existing image. In one embodiment, the presentation comprises a video and the presentation module 615 plays the video on the display. FIG. 9B depicts one embodiment of a presentation playing over the GPS navigation map. In the depicted embodiment, the presentation is an image of a woman displayed over a GPS navigation interface 930 although other various presentations may be used. For example, the presentation may include a video of a person describing a nearby restaurant displayed over a pre-existing image of a GPS navigation map.

In one embodiment, the presentation module 615 displays a stored presentation from the console. In some embodiments, the presentation module 615 may also provide a discount code for goods/services at a particular commercial entity associated with a presentation. In one embodiment where the client 115 is in use by a dispatcher, the presentation module 615 presents presentations that may be applicable to a dispatcher within a predetermined distance from the dispatcher.

The POI determination module 620 determines one or more points of interest 915a, 915b. In one embodiment, each point of interest 915a, 915b is within a predetermined area from one or more of a location of the vehicle 910 and along a predetermined route of the vehicle 910. In one embodiment, the POI determination module 620 determines one or more points of interest 915a, 915b based on one or more of vehicle characteristics and cartage operator characteristics. For example, the POI determination module 620 may reference the current mileage of the vehicle 910 and determine points of interest 915a, 915b that offer service applicable to the current mileage of the vehicle 910 (e.g. an oil change). In another example, the POI determination module 620 may reference a wedding anniversary of the cartage operator and determine points of interest 915a, 915b that offer applicable goods.

The presentation receiving module 625 receives one or more presentations at a console in communication with the display and stores the one or more presentations. The one or more presentations may be for points of interest 915a that are a predetermined distance from one or more of a location of the vehicle 910 and along a predetermined route of the vehicle 910. Displaying the presentation over the portion of the pre-existing image of the display may include displaying a stored presentation from the console.

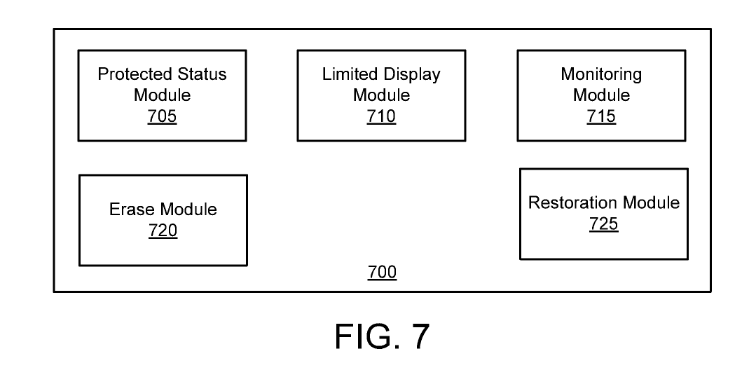

FIG. 7 illustrates one embodiment of an apparatus 700 for an electronic cartage application. Specifically, the apparatus 700 may comprise one embodiment of one or more of the cartage application manager 205 and the client-side cartage apparatus 210. Specifically, the modules in the apparatus 700 may reside in one or more of the cartage application manager 205 and the client-side cartage apparatus 210. The description of the apparatus 700 refers to elements of FIGS. 1-2, like numbers referring to like elements. The apparatus 700 includes one or more of a protected status module 705, a limited display module 710, a monitoring module 715, an erase module 720, and a restoration module 725.

The protected status module 705, in one embodiment, places a console comprising cartage data in a protected status. The cartage data may be produced by a plurality of cartage applications executing on the console. In one embodiment, the protected status module 705 automatically generates a cartage operator status entry in the log in response to placing the console in the protected status. This cartage operator status entry may specify an inspection event. For example, if the cartage operator is pulled aside for an inspection, the cartage operator may notify the protected status module 705 (e.g. through a user interface on a display of the console) to enter the protected status. In one embodiment, the protected status module 705 forces a backup of cartage application data to the central server 105/central storage in response to placing the console in a protected status.

The limited display module 710, in one embodiment, displays a limited subset of cartage data on the display in communication with the console. In one embodiment, the limited subset of cartage data includes cartage operator status entries for a current day and a plurality of previous days. For example, the limited subset of cartage data may include the current day's log and the log for the previous seven days.

The monitoring module 715, in one embodiment, monitors for an access attempt to retrieve information stored on the console, to synchronize with the console, and the like. In one embodiment, the monitoring module 715 monitors for a USB device to attempt to connect with the console.

The erase module 720, in one embodiment, erases a memory of the console in response to detecting an erase event. The erase event may be an access attempt as detected by the monitoring module 715. The erase event may also include receiving an erase command from a remote application, such as from the cartage application manager 205. For example, if the console is stolen, the cartage application manager 205 may transmit an erase command the next time the console communicates with the cartage application manager 205.

The restoration module 725, in one embodiment, restores data to the memory of the console in response to a restore operation from a remote application. For example, if the memory of the console has been erased, the restoration module 725 may restore saved data for the console.

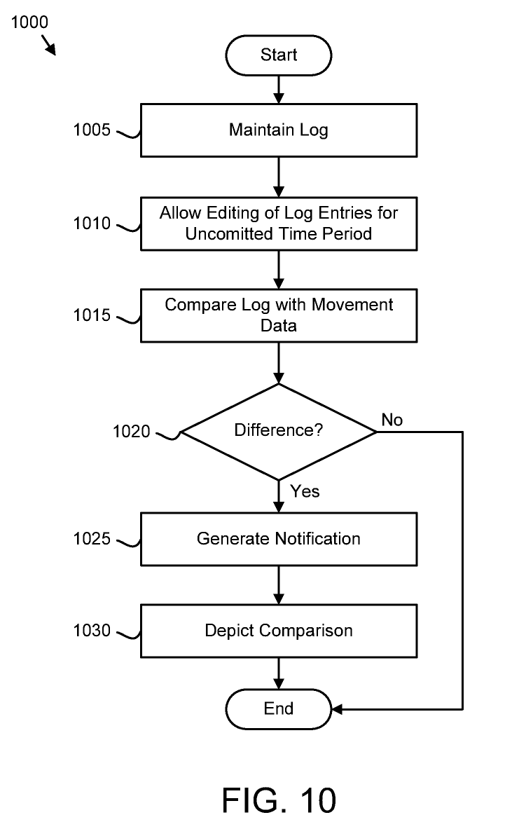

FIG. 10 depicts one embodiment of a method 1000 for a log of cartage operator status entries. The method 1000 may substantially include the steps to carry out at least a portion of the functions presented above with respect to the operation of the described apparatus and system of FIGS. 1-3. The description of the method 1000 refers to elements of FIGS. 1-3, like numbers referring to like elements.

The method 1000 begins and the log module 305 maintains 1005 a log of cartage operator status entries for a cartage operator. The log module 305 allows 1010 the cartage operator to edit status entries for an uncommitted time period (e.g. the current day). The comparison module 310 compares 1015 the log of cartage operator status entries for a particular time period with automated movement data for a vehicle operated by the cartage operator during the particular time period. If the detection module 315 detects 1020 a difference between the log of cartage operator status entries and the automated movement data that exceeds a predetermined threshold, the notification module 325 generates 1025 a notification and the depiction module 320 visually depicts 1030 a comparison of the log of cartage operator status entries and the automated movement data. Then, the method 1000 ends.

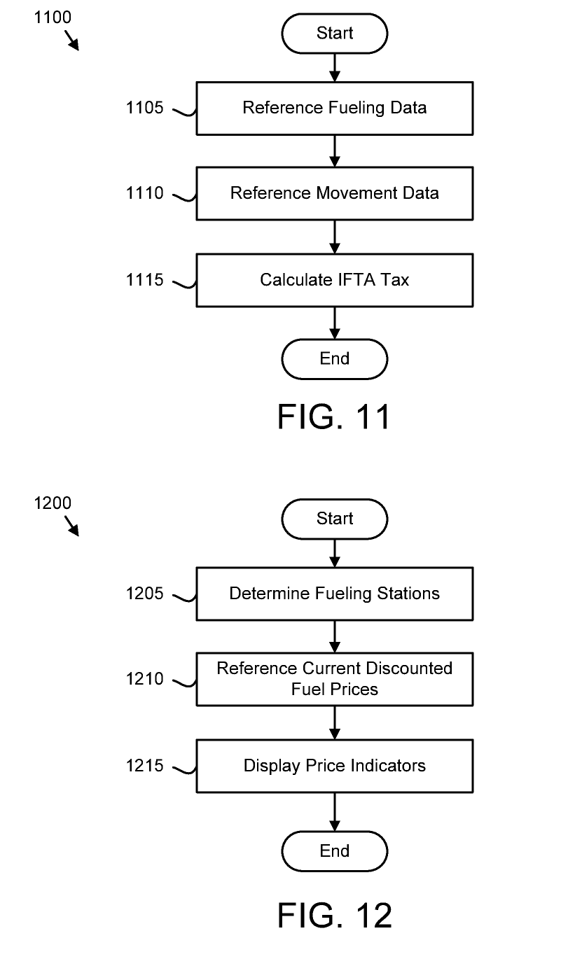

FIG. 11 depicts one embodiment of a method 1100 for calculating an IFTA tax. The method 1100 may substantially include the steps to carry out at least a portion of the functions presented above with respect to the operation of the described apparatus and system of FIGS. 1-2 and 4. The description of the method 1100 refers to elements of FIGS. 1-2 and 4, like numbers referring to like elements.

The method 1100 begins and the fuel reference module 405 references 1105 fueling data of one or more fuel purchase transactions for the vehicle. The fueling data may be collected as part of the one or more fuel purchase transactions. The movement reference module 410 then references 1110 movement data for the vehicle. The movement data may include a distance traveled by the vehicle in one or more jurisdictions. The calculation module 415 then calculates 1115 an International Fuel Tax Agreement (“IFTA”) tax for the one or more jurisdictions from the fueling data and the movement data and the method 1100 ends.

FIG. 12 depicts one embodiment of a method 1200 for displaying fuel price indicators for a plurality of fueling stations. The method 1200 may substantially include the steps to carry out at least a portion of the functions presented above with respect to the operation of the described apparatus and system of FIGS. 1-2 and 5. The description of the method 1200 refers to elements of FIGS. 1-2 and 5, like numbers referring to like elements.

The method 1200 begins and the station determination module 505 determines 1205 a plurality of fueling stations within a predetermined distance of a route of the vehicle. Next, the fuel price reference module 510 references 1210 referencing current discounted fuel prices for the plurality of fueling stations. The discounted fuel prices may be based on a discount program.

The indicator display module 515 may display 1215 fuel price indicators for the plurality of fueling stations on a navigation display. The fuel price indicators may include the discounted fuel prices. Then, the method 1200 ends.

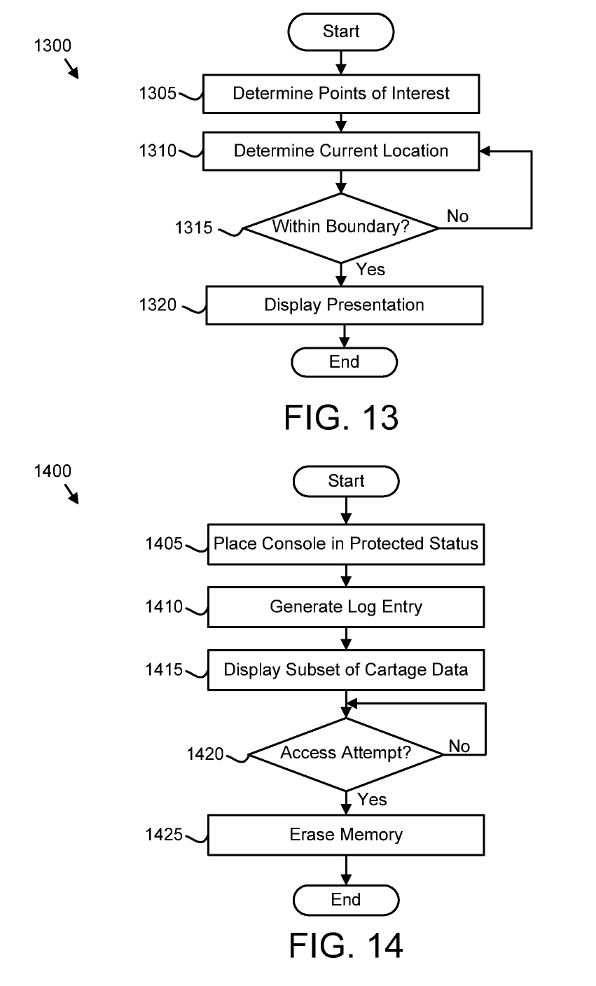

FIG. 13 depicts one embodiment of a method 1300 for displaying a presentation. The method 1300 may substantially include the steps to carry out at least a portion of the functions presented above with respect to the operation of the described apparatus and system of FIGS. 1-2 and 6. The description of the method 1300 refers to elements of FIGS. 1-2 and 6, like numbers referring to like elements.

The method 1300 begins and the POI determination module 620 determines 1305 one or more points of interest. Next, the location determination module 605 determines 1310 a current location of the vehicle. Next, the boundary determination module 610 continually determines 1315 whether the current location of the vehicle is within a boundary, which is around a point of interest. If the boundary determination module 610 determines 1315 that the current location of the vehicle is within the boundary, the presentation module 615 displays 1320 a presentation over a portion of a pre-existing image of a display and the method 1300 ends.

FIG. 14 depicts one embodiment of a method 1400 for placing a console in a protected status. The method 1400 may substantially include the steps to carry out at least a portion of the functions presented above with respect to the operation of the described apparatus and system of FIGS. 1-2 and 7. The description of the method 1400 refers to elements of FIGS. 1-2 and 7, like numbers referring to like elements.

The method 1400 begins and the protected status module 705 places 1405 a console comprising cartage data in a protected status. The protected status module 705 generates 1410 a cartage operator status entry in the log specifying an inspection event. The limited display module 710 displays 1415 a limited subset of cartage data on a display in communication with the console. The monitoring module 715 monitors 1420 for an access attempt to retrieve information stored on the console and the erase module 720 erases 1425 a memory of the console in response to the monitoring module 715 detecting 1420 an erase event. Then, the method 1400 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a log module configured to maintain a log of cartage operator status entries for a cartage operator;
a comparison module configured to compare the log of cartage operator status entries for a particular time period with automated movement data for a vehicle operated by the cartage operator during the particular time period; and
a detection module configured to detect a difference between the log of cartage operator status entries and the automated movement data that exceeds a predetermined threshold.

2. The apparatus of claim 1, further comprising a depiction module configured to visually depict a comparison of the log of cartage operator status entries and the automated movement data.

3. The apparatus of claim 1, further comprising a notification module configured to generate a notification in response to the detection module detecting the difference between the log of cartage operator status entries and the automated movement data that exceeds the predetermined threshold.

4. The apparatus of claim 1, further comprising a log module configured to determine an operator status of the cartage operator and configured to automatically generate an operator status entry in the log in response to determining the operator status of the cartage operator.

5. The apparatus of claim 1, further comprising:
a fuel reference module configured to reference fueling data of one or more fuel purchase transactions for the vehicle, the fueling data from the one or more fuel purchase transactions;
a movement reference module configured to reference movement data for the vehicle, the movement data comprising a distance traveled by the vehicle in one or more jurisdictions; and
a calculation module configured to calculate an International Fuel Tax Agreement (“IFTA”) tax for the one or more jurisdictions from the fueling data and the movement data.

6. The apparatus of claim 5, wherein the fueling data is collected at a point of sale (“POS”) terminal and wherein the fueling data is collected as part of a point of sale fuel discount program.

7. The apparatus of claim 5, further comprising an interface module configured to interface with a fleet fuel card entity and retrieve the fueling data from the fleet fuel card entity.

8. The apparatus of claim 1, further comprising:
a station determination module configured to determine a plurality of fueling stations within a predetermined distance of a route of the vehicle;
a fuel price reference module configured to reference current discounted fuel prices for the plurality of fueling stations, the discounted fuel prices based on a discount program; and
an indicator display module configured to display fuel price indicators for the plurality of fueling stations on a navigation display, the fuel price indicators comprising the discounted fuel prices.

9. The apparatus of claim 8, further comprising a direction module configured to provide navigation directions to a particular fueling station in response to receiving a user selection of the particular fueling station.

10. The apparatus of claim 1, further comprising:
a location determination module configured to determine a current location of the vehicle;
a boundary determination module configured to determine whether the current location of the vehicle is within a boundary, the boundary being around a point of interest;
a presentation module configured to display a presentation over a portion of a pre-existing image of a display in response to determining that the current location of the vehicle is within the boundary, the presentation associated with the point of interest, the pre-existing image remaining substantially visible with the presentation on the display.

11. The apparatus of claim 10, wherein the point of interest comprises a commercial entity and wherein the presentation comprises an advertisement for the commercial entity.

12. The apparatus of claim 10, further comprising a POI determination module configured to determine one or more points of interest, each point of interest one or more of within a predetermined area from a location of the vehicle and along a predetermined route of the vehicle.

13. The apparatus of claim 10, wherein the presentation comprises a video, the apparatus further comprising a presentation receiving module configured to receive one or more presentations at a console in communication with the display and store the one or more presentations, the one or more presentations for points of interest one or more of a predetermined distance from a location of the vehicle and along a predetermined route of the vehicle, wherein the presentation module is configured to display the presentation over the portion of the pre-existing image of the display by displaying a stored presentation from the console.

14. The apparatus of claim 1, further comprising:
a protected status module configured to place a console comprising cartage data in a protected status, the cartage data produced by a plurality of cartage applications executing on the console;
a limited display module configured to display a limited subset of cartage data on a display in communication with the console; and
a monitoring module configured to monitor for an access attempt to retrieve information stored on the console.

15. The apparatus of claim 14, further comprising an erase module configured to erase a memory of the console in response to detecting an erase event, wherein the erase event comprises one of an access attempt and receiving an erase command from a remote application.

16. A method comprising:
maintaining a log of cartage operator status entries for a cartage operator;
comparing the log of cartage operator status entries for a particular time period with automated movement data for a vehicle operated by the cartage operator during the particular time period; and
detecting a difference between the log of cartage operator status entries and the automated movement data that exceeds a predetermined threshold.

17. The method of claim 16, further comprising:
determining a current location of the vehicle;
determining whether the current location of the vehicle is within a boundary, the boundary being around a point of interest;
displaying a presentation over a portion of a pre-existing image of a display in response to determining that the current location of the vehicle is within the boundary, the presentation associated with the point of interest, the pre-existing image remaining substantially visible with the presentation on the display.

18. The method of claim 17, further comprising:
referencing fueling data of one or more fuel purchase transactions for the vehicle, the fueling data collected as part of the one or more fuel purchase transactions;
referencing movement data for the vehicle, the movement data comprising a distance traveled by the vehicle in one or more jurisdictions; and
calculating an International Fuel Tax Agreement (“IFTA”) tax for the one or more jurisdictions from the fueling data and the movement data.

19. A computer program product comprising a computer readable storage medium storing computer usable program code executable to perform operations, the operations comprising:
maintaining a log of cartage operator status entries for a cartage operator;
comparing the log of cartage operator status entries for a particular time period with automated movement data for a vehicle operated by the cartage operator during the particular time period; and
detecting a difference between the log of cartage operator status entries and the automated movement data that exceeds a predetermined threshold.

20. The computer program product of claim 19, wherein the computer program product further comprises operations for:
placing a console comprising cartage data in a protected status, the cartage data produced by a plurality of cartage applications executing on the console;
displaying a limited subset of cartage data on a display in communication with the console; and
monitoring for an access attempt to retrieve information stored on the console.
